(19) United States
(12) Patent Application Publication
(10) Pub. No.: US 2008/0235629 A1
(43) Pub. Date: Sep. 25, 2008

(54) DISPLAY OF MULTI-SIDED USER OBJECT INFORMATION IN NETWORKED COMPUTING ENVIRONMENT

(75) Inventors: Dorrian Grant Porter, Menlo Park, CA (US); Adrian Jeremy Tymes, Mountain View, CA (US); Huajun Qin, Fremont, CA (US); Andrew William Stack, Redwood City, CA (US); Irv Remedios, San Francisco, CA (US); Jason Broughton, San Francisco, CA (US); David Lothele Williams, Belmont, CA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: MOZES INCORPORATED, Palo Alto, CA (US)

(21) Appl. No.: 12/052,199

(22) Filed: Mar. 20, 2008

Related U.S. Application Data
(60) Provisional application No. 60/896,814, filed on Mar. 23, 2007.

(51) Int. Cl. G06F 3/048

(52) U.S. Cl. 715/849

(57) ABSTRACT

User information is displayed as a multi-sided user object for different sides of the multi-sided user object on a device having a limited display. The user object can be a user profile and the multi-sided user object can be a multi-sided user profile object where updates to the user profile can be made directly via a PC, or via the device via changes made to side(s) of the multi-sided user profile object. The multi-sided user object can be displayed as part of any client process, e.g., an application, a networked service or web widget display system.

### CROSS-REFERENCE TO RELATED APPLICATIONS

This application claims priority to U.S. Provisional Application Ser. No. 60/896,814, filed on Mar. 23, 2007, entitled “PORTABLE AND SHARABLE PROFILE FOR MOBILE DEVICES”, the entirety of which is incorporated herein by reference.

### TECHNICAL FIELD

The subject disclosure relates to representing and displaying user object information as multi-sided user object information on mobile computing devices in a networked computing environment.

### BACKGROUND

By way of background concerning conventional systems, the networked computing realm has generally evolved into two divergent classes of computing devices: (A) larger, relatively non-portable computing devices with full input, processing, output and/or storage functionality, such as PCs and (B) smaller portable computing devices, such as mobile phones, with the same or similar functionality as their larger counterparts, but with more limited input, processing, output and/or storage characteristics due to the more limited capabilities (e.g., smaller displays, smaller input, slower processors, less storage, etc.).

With respect to the larger, standalone computing devices, traditional Web applications and services, such as a social networking application, have allowed users to enter individual or group profile information, and share that information with others; however, traditionally, this has not been optimal for display on mobile devices due to the limited screen size. Some conventional systems have attempted to automatically resize or dynamically “re-flow” the web site content for display on mobile devices with limited screen size, but such techniques inevitably fail to provide a fully satisfactory experience.

Displays have become constrained elsewhere too. For instance, a single web “page” has evolved beyond the single presentation of information by a single content provider. Today, there are many content owners delivering content to a typical web page according to sometimes complex relationships, e.g., the web site owner, third parties that develop applications or web widgets for the web site, advertisement providers (e.g., banner ads, right side ads, top center, etc.) and so on. In this respect, a variety of content providers may all be required to, in effect, share screen space, and thus the same problem presents itself with web pages as devices—there is not enough display space for a single content owner to display all of the information.

Accordingly, it would be desirable to provide an improved display experience for displaying centralized user information retrieved from a networked computing environment. The above-described deficiencies of today's device display systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Various embodiments of an improved display technique for displaying user information as a multi-sided user object are provided for displaying different sides of the multi-sided user object on a device. In one non-limiting embodiment, the user object is a user profile and the multi-sided user object is a multi-sided user profile object where updates to the user profile can be made directly via a PC, or via a device with limited display aspect via changes made to side(s) of the multi-sided user profile object. The multi-sided user object can be displayed as part of any client process, e.g., an application, a networked service or web widget display system.

These and other embodiments are described in more detail below.

### BRIEF DESCRIPTION OF THE DRAWINGS

Various non-limiting embodiments are further described with reference to the accompanying drawings in which:

FIG. 1 is a block diagram representing exemplary non-limiting details of a user object management system;

FIG. 2 is a block diagram representing exemplary non-limiting details of an implementation showing the creation of the user information and the subsequent steps resulting in the display of multi-sided object information on a device;

FIG. 3 is a block diagram representing exemplary non-limiting details of an implementation based on keyword retrieval of multi-sided profile objects for display on a device;

FIG. 4 illustrates that the organization of user objects as stored in a centralized data store is separate from the representation of the information of the user objects as various 3-D objects having multiple faces;

FIG. 5 is a flow diagram illustrating an exemplary, non-limiting process for requesting a multi-sided user object for display on the device;

FIGS. 6 and 7 are screenshots of an exemplary, non-limiting web site for creating and managing profile information in accordance with an embodiment;

FIG. 8 illustrates an exemplary, non-limiting display of a first side of a user profile object according to a flip card (2-sided) embodiment on a mobile phone display screen;

FIG. 9 illustrates an exemplary, non-limiting user interface for rotating or flipping the multi-sided user object according to an embodiment;

FIG. 10 is a flow diagram illustrating an exemplary, non-limiting process for requesting and rotating a multi-sided user object in accordance with an embodiment;

FIG. 11 is a block diagram representing exemplary non-limiting networked environments in which various embodiments described herein can be implemented; and

FIG. 12 is a block diagram representing an exemplary non-limiting computing system or operating environment in which one or more aspects of various embodiments described herein can be implemented.

### DETAILED DESCRIPTION

### Overview

As a roadmap for what follows, an overview of various embodiments presented herein is first presented. Then, exemplary, non-limiting optional implementations are discussed in more detail for supplemental context and understanding. Next, some non-limiting computing apparatus and networked apparatus are described as potential operating environments for the various embodiments described herein.

As discussed in the background, among other things, conventional systems do not adequately represent and display information entered into web sites from PCs on devices. Accordingly, in various non-limiting embodiments, user information is displayed on a device, e.g., via a mobile device or a web widget of a web page, as a multi-sided user object such that different sides of the multi-sided user object are displayed when requested by the user, and the multi-sided user object can be rotated from side to side to display the different sides of the multi-sided user object. The multi-sided user object can be displayed as part of any client process, e.g., an application, a networked service or web widget display system or engine. While some of the embodiments herein are described in the context of a mobile device such as a mobile phone, the ideas are not so limited, but rather are applicable to any computing device having an aspect of display where it would be desirable to present more information than allowed by the 2-D space provided for the user interface component or subcomponent on display.

In one non-limiting embodiment, the user object is a user profile and the multi-sided user object is a multi-sided user profile object where updates to the user profile can be made directly via a PC, or via the device by making changes to side(s) of the multi-sided user profile object. In one aspect, a method for creating and managing profile and other information on the web can be represented as a profile card, which is then converted for use as a two-sided display card object for display on the mobile phone, although any number of sides can be accommodated.

The profile card contains personal identity and other links, e.g., to media, that are located on the web, which the system then translates for display on the mobile phone. For the avoidance of doubt, while some of the embodiments herein are described in the context of user profile information, such embodiments are not limited to profile information, and can include other file types or purposes besides individual identity. Any object created by a user having information that can be represented as a multi-sided object with multiple sides of information related to a common theme can be the subject of the embodiments herein. Such embodiments relating to user profile information are described herein for illustrative purposes in the widely recognized scenarios of e-commerce web sites, social networking web sites, web sites for other outreach reasons, etc., i.e., wherever users commonly create objects representing information representation in a networked data store.

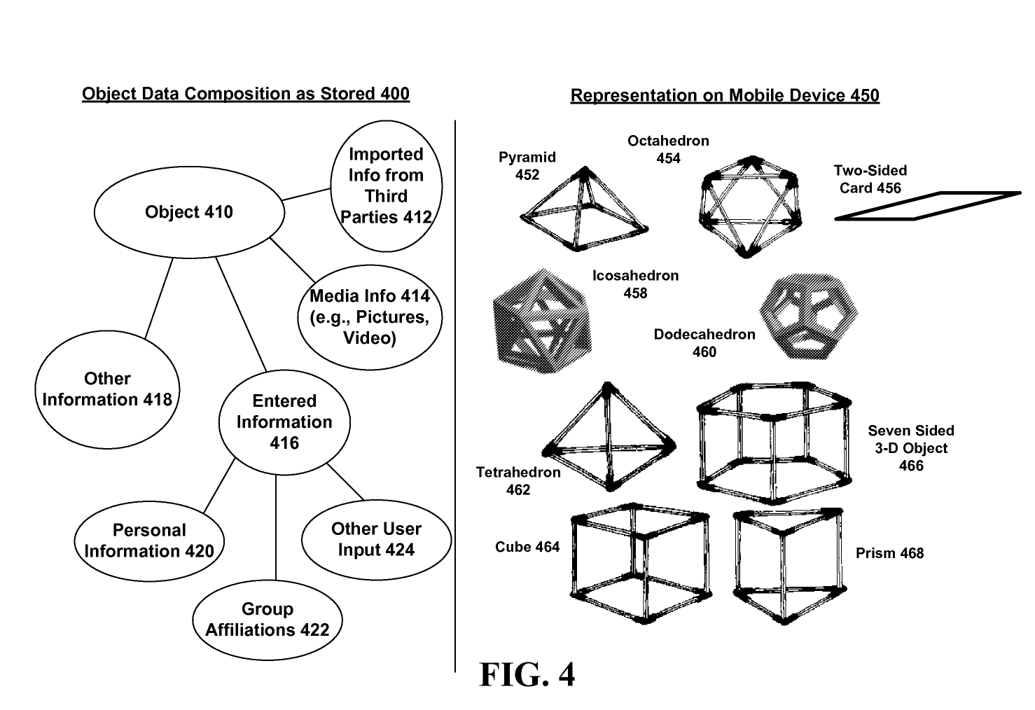

For instance, group identities can be represented in a similar manner. For another example, a media preview card can include sample music and other artist information as part of an artist or album profile, or an upcoming movie can have a profile card that includes preview information related to the upcoming movie. Thus, any information that can be modeled in the real world as a physical card, such as a baseball card with a photo on the front, and statistics on the back, is contemplated by the embodiments described herein. Moreover, for the avoidance of doubt, multi-sided objects having more than two sides are contemplated herein, e.g., as described in connection with FIG. 4 below.

### Multi-Sided User Object Representation and Display

In this regard, embodiments are described herein wherein a user object can be created and managed on the web. In accordance with the various embodiments described in more detail below, a user can create a profile (or other user object) at a social networking web site, or other web site, and manage that profile from centralized storage, and retrieve that profile on any form factor of device. For instance, an application or web service process on the device can retrieve the profile, and display the profile for the form factor of the device. On a device, such as a portable computing device, or web widget on display, the screen space may be limited and accordingly, the display of user object information as a multi-sided user object is advantageously an intuitive way for users to navigate user object information.

The various embodiments herein describe profile, or other, information that can be represented as a multi-sided card, such as a two-sided card. Thus, the device, such as a mobile device, includes a way to turn over the card to view the other side, or rotate the object to other sides. This can be a keyboard command, a command activated via a user interface component, or other software command activated by the user of the mobile phone. In one embodiment, the device includes a touch screen user interface, such that activating a specific portion of the touch screen, or a swiping action on a displayed side of the card on display in effect turns the card over, consistent with the concept of turning over a card in the physical world (or otherwise rotating a 3-D object).

In another embodiment, orientation sensors in the device can inform which side is displayed. For instance, each time the device is turned over, another side of the card can be displayed. In this regard, the mapping of sides of the multi-sided object on display to sides of an intuitively understood 3-D Earthly object serves at least two main purposes: (1) the user grasps how to change to other sides of information via commonly understood 3-D object abstractions of the physical world and (2) the subsets of information displayed on each side of the multi-sided user object can concisely represent different parts of the whole user information without presenting all of the user object information at once. In this regard, conventional systems have attempted to resize the information from web stores on mobile phones without satisfying either goal.

In one embodiment, multi-sided user objects are sharable with other users, but editable or updatable only by a user with password entry. Optionally, any changes made to information of a user object by the authorized user are global, i.e., all future accesses of the information of the user object reflect the changes.

As mentioned, in various embodiments, a multi-sided user object, such as a card, has multiple sides that are managed and created on the web. This allows the card to be “flipped over” or rotated when displayed on a device, such as a mobile phone. When displayed on a mobile phone, for example, the card or other multi-sided user object can be fitted for multiple different types of handsets by specification. Various embodiments include the ability to edit the user information both on the device, such as a mobile phone and on the web, and have changes reflected in either spot, i.e., anywhere a device can update the user information.

In one embodiment, a multi-sided user objects is displayed on a device display via an application executing on the device. In other embodiments, the display is dictated by a Web services experience undertaken by the mobile phone. In yet other embodiments, web widgets executing on the mobile phone include a user interface component for displaying the multi-sided user object information, and rotating among the various sides. In this regard, for additional background, widgets are downloadable interactive virtual tools that provide services such as showing the user the latest news, the current weather, the time, a calendar, a dictionary, a map program, a calculator, desktop notes, photo viewers, or even a language translator, among many diverse other things.

To elaborate on the notion of a multi-sided user object, for the avoidance of doubt, any number of sides can be accommodated for a multi-sided user object. A user can dictate the number of sides (“7 sides make sense for my information”), or the context of an application or service might dictate the number of sides (“baseball has 9 innings” or “the world has 7 continents”). Some commonly referred to 3-D objects in the physical world with equal sides include dodecahedron (twelve sides), decahedron (ten sides), octahedron (eight sides), cubes (six sides) and tetrahedrons (four sides).

In this regard, as a non-limiting example of 3-D solids, Platonic solids are perfectly regular solids with the following conditions: all sides are equal and all angles are the same and all faces are identical. In each corner of such a solid, the same number of surfaces collide. Five known Platonic solids include the tetrahedron, hexahedron, octahedron, dodecahedron or icosahedron. These are only examples of 3-D objects that can be reduced to a multi-sided user object as described herein for displaying different sides. For clarity, and as described in the embodiments below, any number of sides two or greater can be included by a multi-sided user object in accordance with the various embodiments described herein.

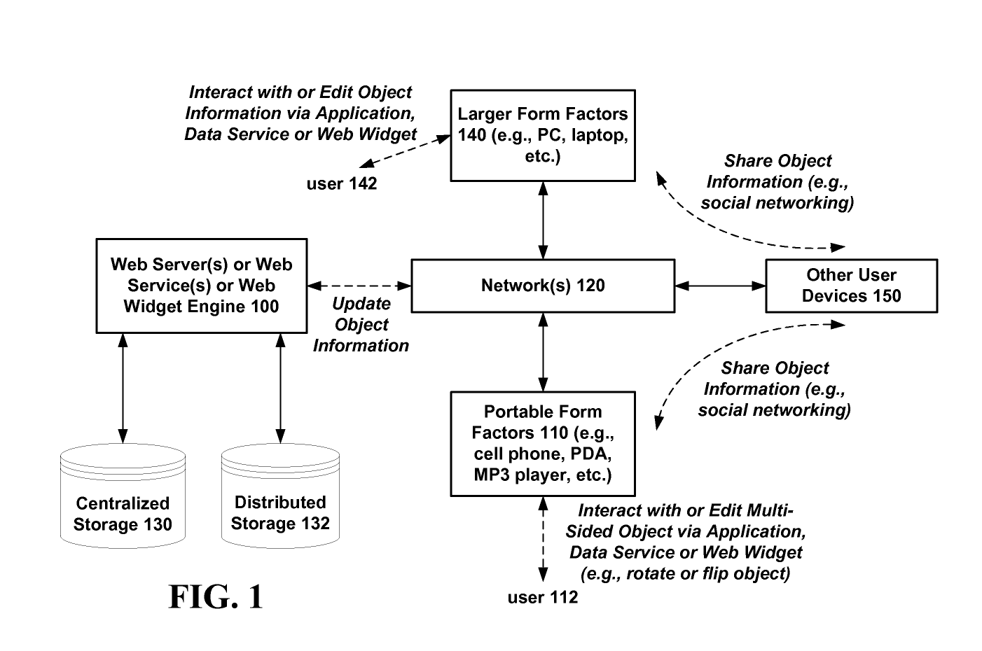

In FIG. 1, a user 142 can interact with a larger form factor 140, such as a PC, laptop, etc. The user 142 can interact with or edit user object information via an application, data service or web widget service. In this respect, via network(s) 120, web server(s) or web (service(s) or web widget engine 100, user object information can be created in centralized storage 130 or distributed storage 132. A user 142 can also update the object information via connectivity to the web server(s) or web (service(s) or web widget engine 100 by way of network(s) 120. FIG. 1 also illustrates that the embodiments described herein contemplate the ability to share object information from any of the larger form factors 140 connected to network(s) 120, but also to share object information from any of the smaller portable form factor(s) 110. Such information can be shared with other user devices 150. User 112, which can also be user 142, in this regard, can interact with, or edit, multi-sided object information via an application, network service or web widget. Any updates are globally reflected for the given user object.

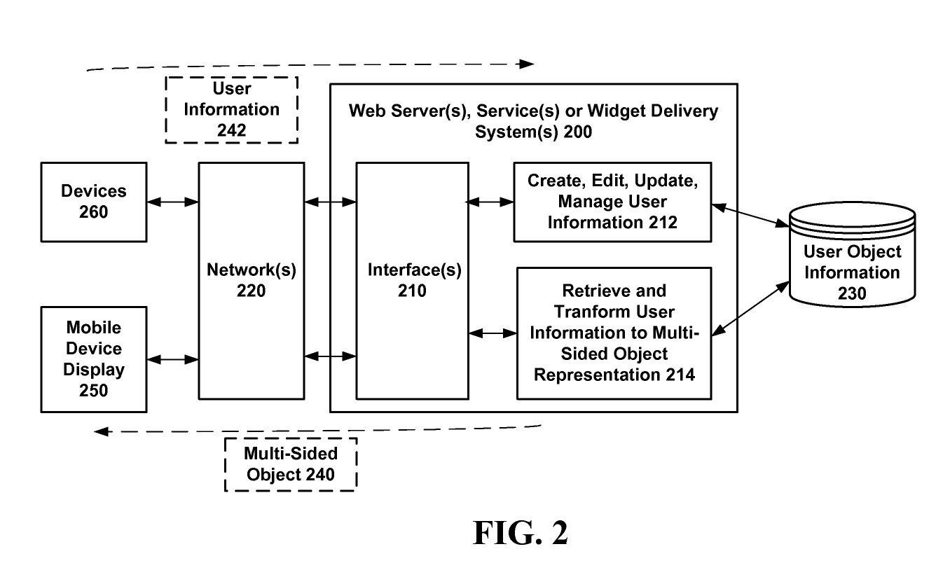

FIG. 2 illustrates a general framework for a networked environment in which users create and manage user object information, which is then transformed for display as a multi-sided or multi-faced user object for a device display. In this regard, devices 260 can create a user object by sending user information 242. One can appreciate that the term user information can include any kind of data somehow relating to a user. User information 242 is sent to web server(s), service(s) or widget delivery system(s) 200 via network(s) 220 and received via interfaces(s) 210, such that devices 260 can create, edit, update and manage user information 212 in user object information store 230.

Once stored or updated in user object information store 230, a device 250 (including a limited display) may request a multi-sided user object representation from the web server(s), service(s) or widget delivery system(s) 200. Component 214 retrieves and transforms user information to a multi-sided object representation, which is transmitted via interface(s) 210 and network(s) 220 to the requesting device. The multi-sided object 240 can thus be displayed one side at a time on device display 250.

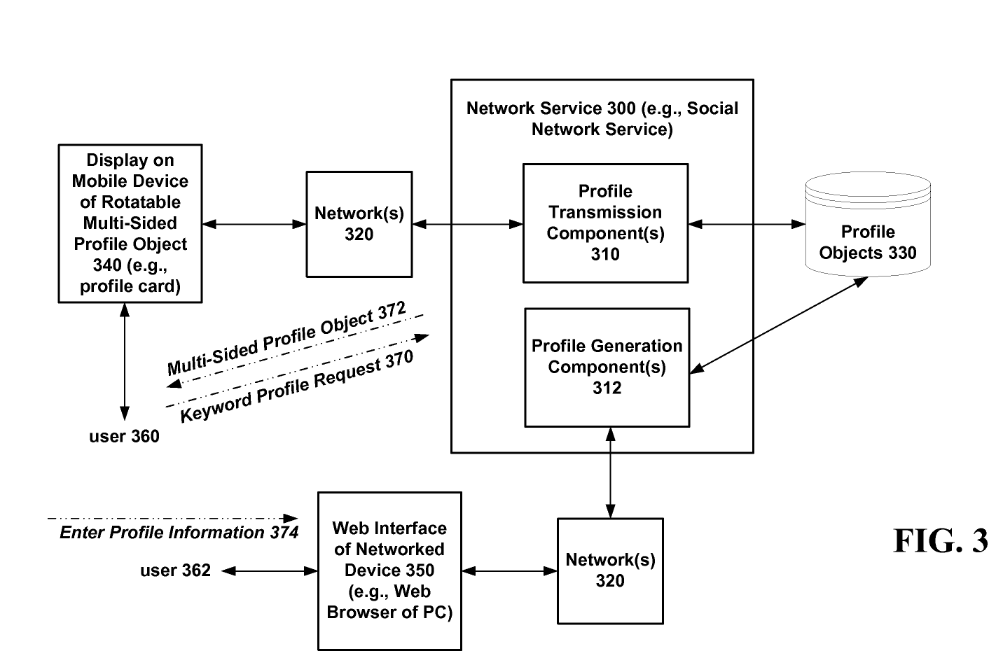

FIG. 3 illustrates a non-limiting embodiment wherein a user 362 can enter profile information 374 via a web interface of a networked device 350, e.g., a web browser of a PC for interacting with a social networking web site (e.g., myspace or facebook). Such interaction occurs via networks 320. A network service 300, such as a social network service receives the profile information 374 at profile generation component(s) 312 and profile objects 330 result. In this regard, profile objects 330 can be stored according to any known storage, such as flat file, multi-dimensional representation, relational storage, distributed storage, etc. Once the profile object data store 330 is created, users can access the information via a variety of devices 340 as a multi-sided user object. The multi-sided user object can be received via network(s) 320 and the networked service 300. For instance, network service 300 can include a profile transmission component 310 that transmits any of profile objects 330 to devices 340 for display as multi-sided profile objects. Optionally, a user 360 can make a keyword profile request 370 for matching profiles to the keywords, and then receive matching multi-sided profile objects 372 from transmission component(s) 310.

FIG. 4 serves to clarify the difference in identity of object data 400 as composed and stored according to the system and a corresponding multi-dimensional object representation 450. For instance, a user object 410 may include any one or more of imported information from third parties 412, media information 414, such as pictures, images, video, audio, etc., entered information 416 including any information that can be entered by a user including personal information 420, group affiliations 422 or other user input 424. In addition, object 410 can include, or contain a reference to, any other information 418 as well. As such the information represented as object 410 can be represented on the device as a multi-sided user object 450. This can include, for example, but is not limited to, a pyramid 452, an octahedron, 454, a two-sided card 456, an icosahedrons, 458, a dodecahedron 460, a tetrahedron 462, a seven sided 3-D object 466, a cube 464 or a prism 468.

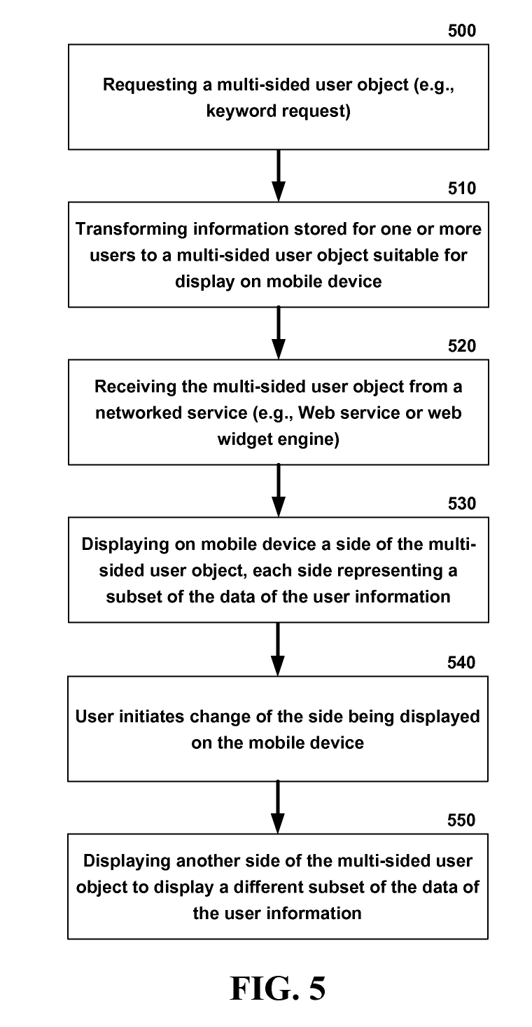

FIG. 5 illustrates a method for interacting with a multi-sided user object on a mobile computing device. At 500, a multi-sided user object is requested. This could be a keyword inquiry (e.g., via a text message service). At 510, the information stored for tone or more users is transformed to a multi-sided user object for display on a device (e.g., a mobile device). At 520, the multi-sided user object is received from the networked service. Each side of the multi-sided user object is generated from a subset of data of a user object defined by a user. At 530, a first side of the multi-sided user object is displayed. At 540, the user can initiate a change to another side of the multi-sided user object. At 550, the change is effected and a graphical change occurs to simulate the rotation of the multi-sided object to the other side. In one embodiment, the method includes transforming the user object into the multi-sided user object for the acts of displaying. In another aspects, changes to the user profile via the web site, or changes to any information of any side of the multi-sided user object are committed globally such that all future accesses of the user object information reflects any updates from any authorized device on behalf of the user.

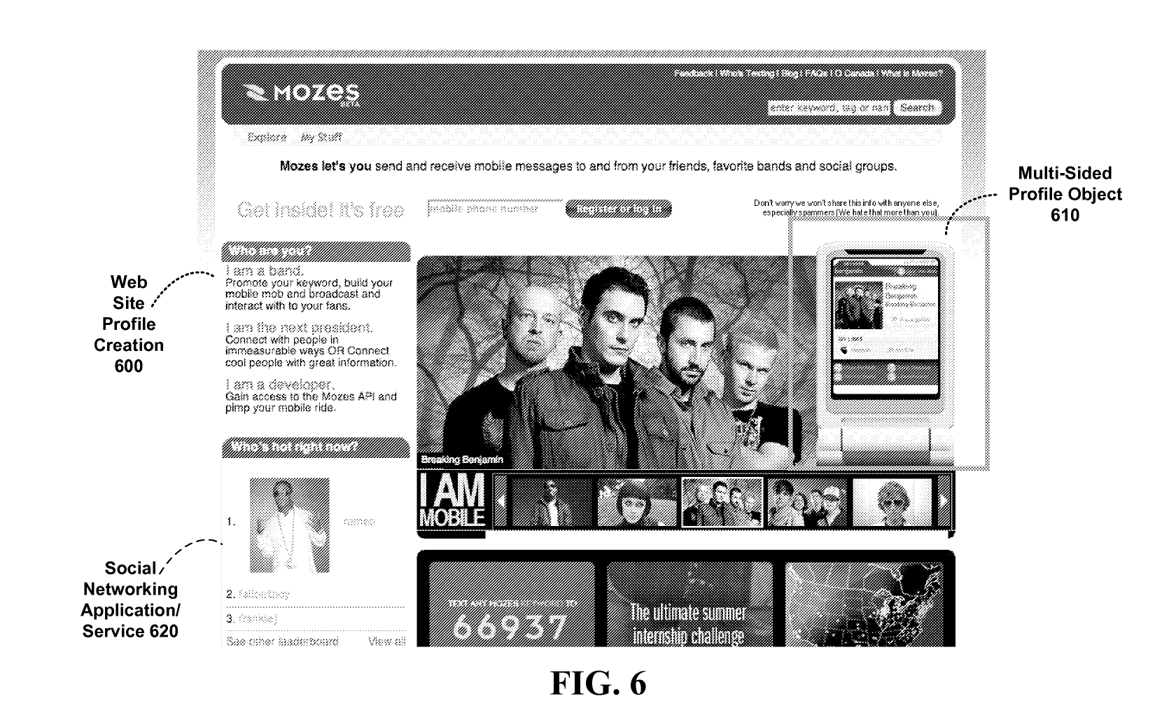

FIG. 6 illustrates a non-limiting implementation of an entry screen for a web site that allows creation of profiles 600. As shown, creating the profile enables a translation to a multi-sided profile object 610 for more suitable display on a device. Such profile objects 610 can be well suited for further action via social networking application/services 620. For the avoidance of doubt, FIG. 6 represents just one example of a web page or web site, and can be applied via any web page wherein a user can interface with an application or service to create user objects, which can be transformed to three-dimensional objects for display anywhere that screen space may be limited for the amount of information to be displayed.

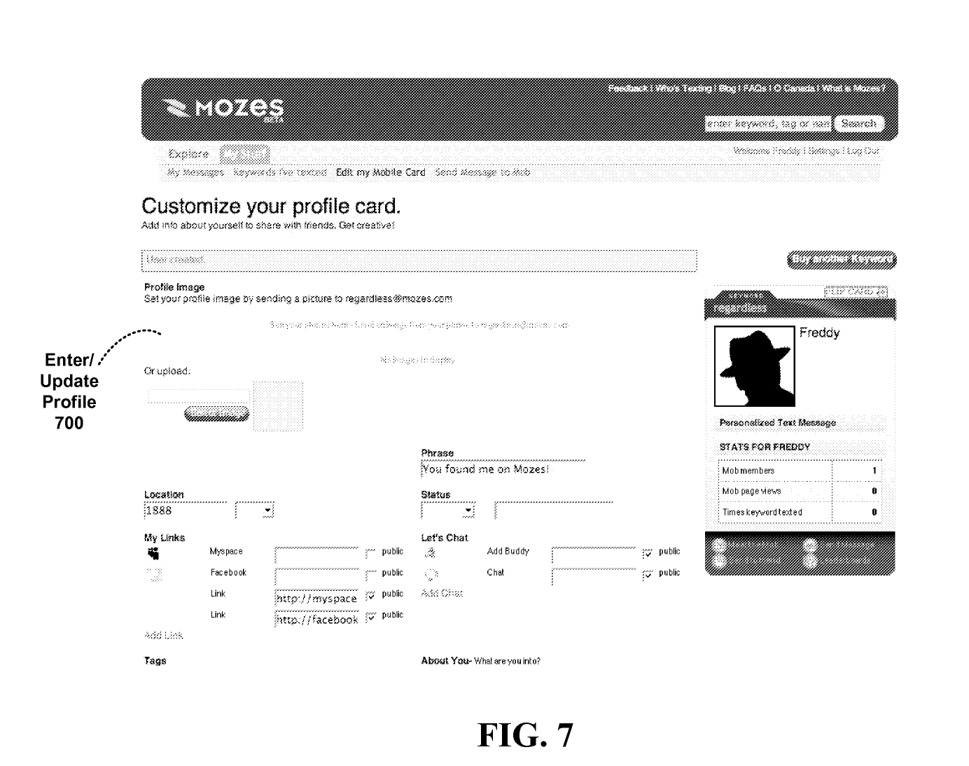

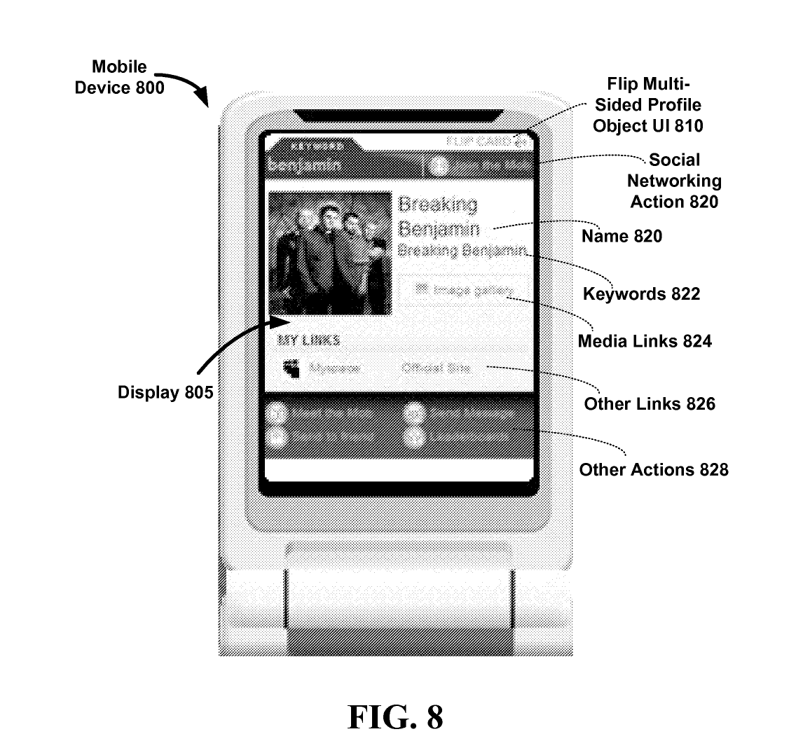

For illustration of the concept only, FIG. 7 illustrates representative, non-limiting web site 700 for entering or updating fields of a user profile on behalf of a user. FIG. 8 illustrates the device 800 that has a display 805 for displaying one or more sides of the multi-sided profile object via UI 810. While not limiting, the display may be part of a social networking action 820. In addition, for some non-limiting fields represented in the UI 810, any of name 820, keywords 822, media links 824, other links 826 or other actions 828 can be represented via UI 810.

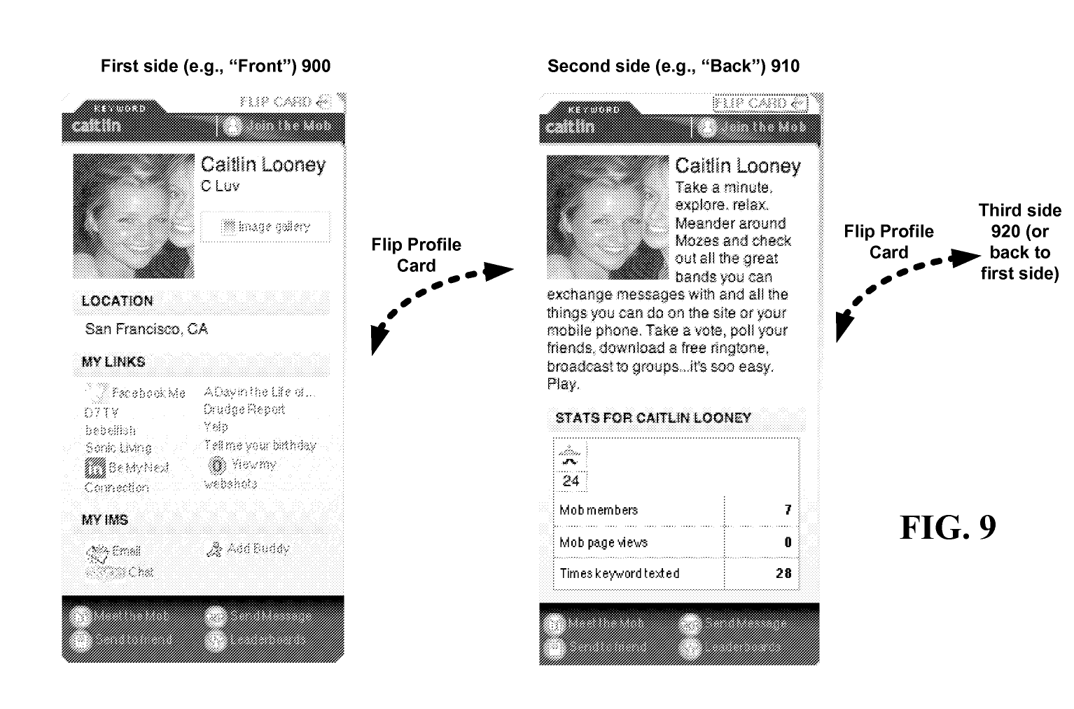

To illustrate the power of various embodiments, a first side 900 of a multi-sided user object can be rotated, or flipped, to display a second side 910 of the multi-sided user object, as illustrated in FIG. 9. In turn, to illustrate any embodiment with three or more sides, a third side 920 can then be requested by a user for display. Next, fourth, fifth sides, etc. can be displayed depending on the number of sides of the multi-sided object requested for display on the device.

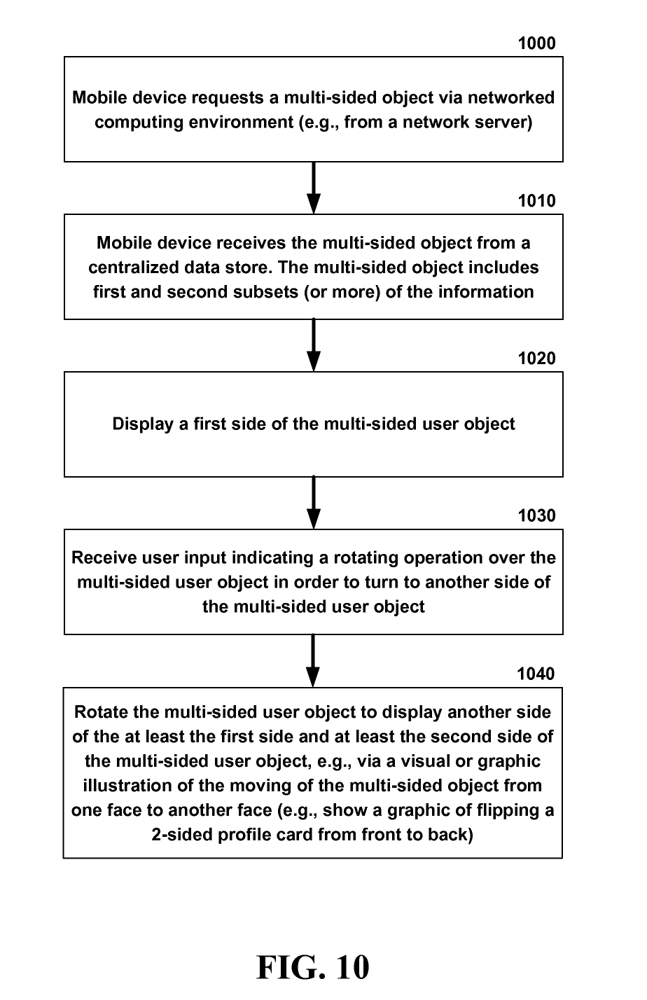

FIG. 10 is a flow diagram representing a general process for requesting and displaying multi-sided user object information in accordance with various embodiments. At 1000, a device requests a multi-sided profile object via a networked computing environment. At 1010, the device receives the multi-sided profile object from a centralized data store including receiving at least a first side representing a first subset of profile information and at least a second side representing a second subset of the profile information. At 1020, the device displays, via a display of the device, either the first side or the second side of the multi-sided user object. At 1030, a user initiates the rotation of the multi-sided user object to display another side of the multi-sided user object. For instance, where the multi-sided user object is a profile card with two sides, the rotating includes flipping the profile card from a first side of the profile card to the second side of the profile card, and visually representing the same on the device.

### Exemplary Networked and Distributed Environments

One of ordinary skill in the art can appreciate that the various embodiments of display techniques described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may request multi-sided user object information as described for various embodiments of the subject disclosure.

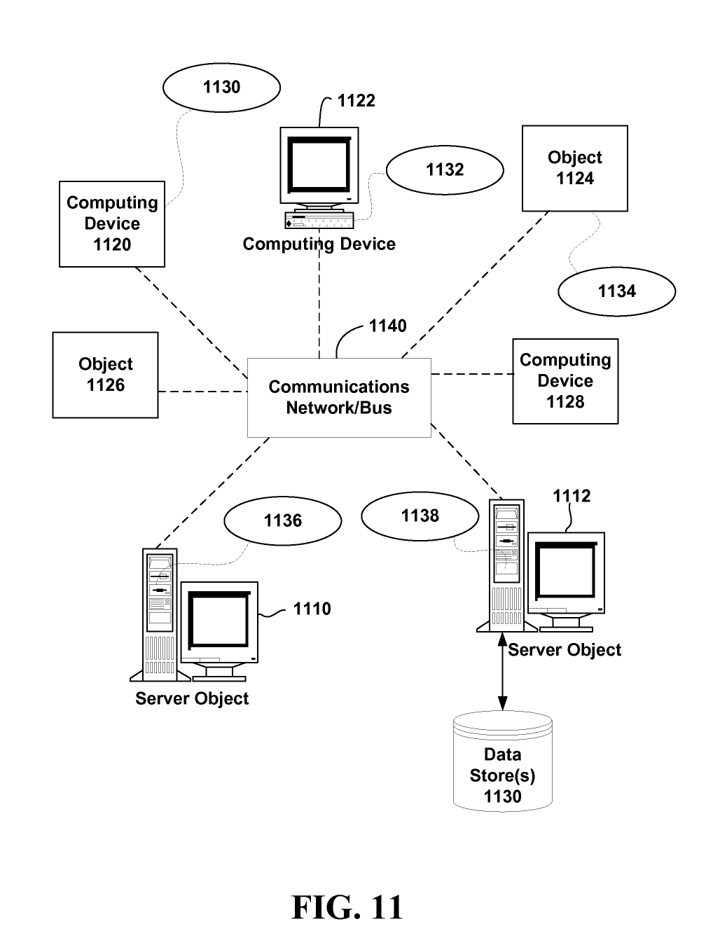

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that objects 1110, 1112, etc. and computing objects or devices 1120, 1122, 1124, 1126, 1128, etc. may comprise different devices, such as PDAs, audio/video devices, mobile phones, MP3 players, personal computers, laptops, etc.

Each object 1110, 1112, etc. and computing objects or devices 1120, 1122, 1124, 1126, 1128, etc. can communicate with one or more other objects 1110, 1112, etc. and computing objects or devices 1120, 1122, 1124, 1126, 1128, etc. by way of the communications network 1140, either directly or indirectly. Even though illustrated as a single element in FIG. 11, network 1140 may comprise other computing objects and computing devices that provide services to the system of FIG. 11, and/or may represent multiple interconnected networks, which are not shown. Each object 1110, 1112, etc. or 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the systems for displaying multi-sided user object information provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the display of multi-sided user object information as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 11, as a non-limiting example, computers 1120, 1122, 1124, 1126, 1128, etc. can be thought of as clients and computers 1110, 1112, etc. can be thought of as servers where servers 1110, 1112, etc. provide data services, such as receiving data from client computers 1120, 1122, 1124, 1126, 1128, etc., storing of data, processing of data, transmitting data to client computers 1120, 1122, 1124, 1126, 1128, etc., although any computer can be considered a client, a server, or both, depending on the circumstances. Any of these computing devices may be processing data, such as user profile data, or requesting services or tasks that may implicate the multi-sided user objects as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing transmitting or receiving of multi-sided user object information can be provided standalone, or distributed across multiple computing devices or objects.

In a network environment in which the communications network/bus 1140 is the Internet, for example, the servers 1110, 1112, etc. can be Web servers with which the clients 1120, 1122, 1124, 1126, 1128, etc. communicate via any of a number of known protocols, such as the hypertext transfer protocol (HTTP). Servers 1110, 1112, etc. may also serve as clients 1120, 1122, 1124, 1126, 1128, etc., as may be characteristic of a distributed computing environment.

### Exemplary Computing Device

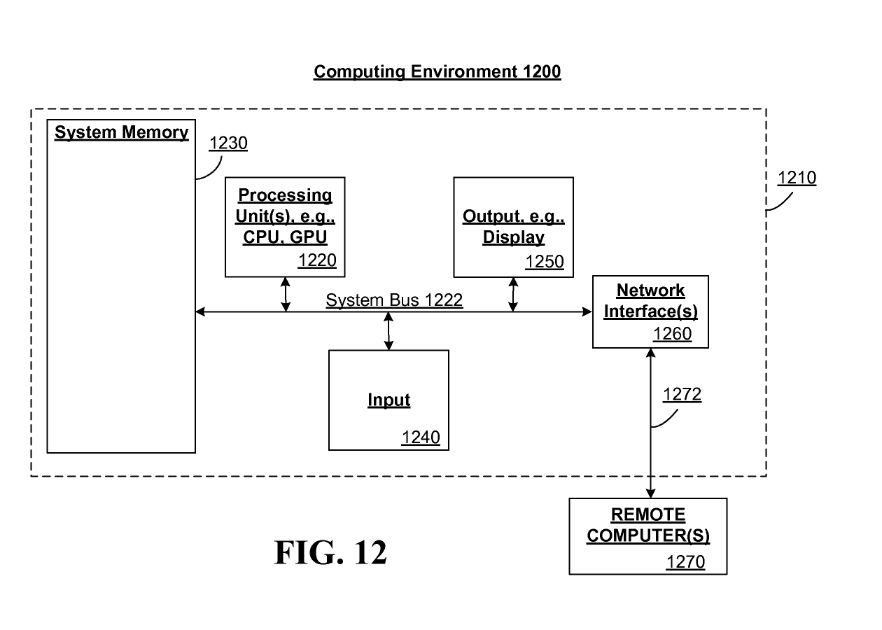

As mentioned, advantageously, the techniques described herein can be applied to any device where there may be limited screen space in order to display desired subsets of the information via a multi-sided object. It should be understood, therefore, that handheld, portable and other computing devices and computing objects of all kinds are contemplated for use in connection with the various embodiments, i.e., anywhere that a device may enter, update, or display user object information. Accordingly, the below general purpose remote computer described below in FIG. 12 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 12 thus illustrates an example of a suitable computing system environment 1200 in which one or aspects of the embodiments described herein can be implemented, although as made clear above, the computing system environment 1200 is only one example of a suitable computing environment and is not intended to suggest any limitation as to scope of use or functionality. Neither should the computing environment 1200 be interpreted as having any dependency or requirement relating to any one or combination of components illustrated in the exemplary operating environment 1200.

With reference to FIG. 12, an exemplary remote device for implementing one or more embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

Also, there are multiple ways to implement the same or similar functionality, e.g., an appropriate API, tool kit, driver code, operating system, control, standalone or downloadable software object, etc. which enables applications and services to use the multi-sided user object information as described herein. Thus, embodiments herein are contemplated from the standpoint of an API (or other software object), as well as from a software or hardware object that provides access to the multi-sided user objects. Accordingly, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method for interacting with a multi-sided user object on a computing device, including:
displaying a first side of the multi-sided user object, the first side of the multi-sided user object being generated from a first subset of data of a user object defined by a user comprised of multiple dimensions of data;
receiving input by the computing device to initiate display of at least a second side of the multi-sided user object; and
displaying at least the second side of the multi-sided user object, the at least the second side of the multi-sided user object being generated from a second subset of data from the user object.

2. The method of claim 1, further including:
receiving the user object comprised of the multiple dimensions of data; and
transforming the user object into the multi-sided user object for the acts of displaying.

3. The method of claim 1, further including:
receiving from a networked service based on the user object at least one of a two-sided object, a four-sided object or a six sided object for the acts of displaying.

4. The method of claim 1, wherein the displaying of the first side and at least the second side of the multi-sided user object includes displaying the first side and at least the second side by a client application executing on the device.

5. The method of claim 1, wherein the displaying of the first side and at least the second side of the multi-sided user object includes displaying the first side and at least the second side in a user interface component of a web widget displayed on the device.

6. The method of claim 1, further including:
requesting the multi-sided user object via a Web service provided by one or more Web servers, wherein the device is a mobile device.

7. The method of claim 1, further including:
making changes to information of at least one side of the multi-sided user object; and
automatically transmitting the changes to the information of the at least one side of the multi-sided user object to a networked data store.

8. The method of claim 7, further including reflecting the changes in the user object globally for all networked devices having access to the networked data store.

9. A network service for managing user profile information, wherein the user profile information is displayable on devices as a multi-faced 3-D object rotatable among its faces to display different subsets of the user profile information, including:
a user interface component for creating a user profile having user profile information and for editing the user profile information;
storage for storing the user profile information and any updates made to the user profile information from any device connected to the network service; and
a transform component for transforming the user profile information stored in storage to at least two subsets of the user profile information corresponding to at least two faces of the multi-faced 3-D object, wherein each of the at least two faces is suitable for display on a device.

10. The network service of claim 9, further comprising:
a transmit component for transmitting the at least two subsets of the user profile information to a device in response to a request to display at least one face of the multi-faced 3-D object from the device.

11. The network service of claim 10, wherein transmit component transmits the at least two subsets of the user profile information as part of a web widget delivery to the device.

12. The network service of claim 9, further comprising:
a transmit component for transmitting the at least two subsets of the user profile information to a device in response to at least one keyword received from the device, wherein the at least one keyword matches information in the user profile information, and wherein the device is a mobile device.

13. The network service of claim 9, wherein the user interface component includes a user interface for enabling a user to specify a number of faces for the multi-faced 3-D object.

14. The network service of claim 13, wherein the user interface enables a user to select from at least one pre-set choice of 3-D object including a choice of a 2-sided profile card for prospective display on the device rotatable between a first subset of the user profile information on one side or a second subset of the user profile information on the other side.

15. The network service of claim 13, wherein the user interface enables a user to select from at least one pre-set choice of 3-D object including a choice of a 4-sided profile object for prospective display on the device rotatable among a first subset of the user profile information on a first side, a second subset on a second side, a third subset on a third side or a fourth subset of the user profile information on a fourth side.

16. The network service of claim 9, wherein the user interface component includes a user interface for enabling a user to customize the content for the at least two subsets of the multi-faced 3-D object by explicitly selecting the information for the at least two subsets from the user profile information.

17. The network service of claim 16, wherein the user interface component includes a user interface for enabling a user to customize the content for the at least two subsets of the multi-faced 3-D object by positionally arranging the user profile information.

18. The network service of claim 10, wherein the user profile is a profile for a group of users of the network service.

19. A method for a networked computing environment including mobile devices, including:
requesting by a mobile device a multi-sided profile object via the networked computing environment;
receiving, in response to the requesting, the multi-sided profile object from a centralized data store including receiving at least a first side representing a first subset of profile information and at least a second side representing a second subset of the profile information;
displaying, via a display of the mobile device, a side of the at least the first side and at least the second side of the multi-sided user object; and
in response to user input, rotating the multi-sided user object to display another side of the at least the first side and at least the second side of the multi-sided user object.

20. The method of claim 19, wherein the rotating includes flipping a profile card from a first side of the profile card to the second side of the profile card.
